(19) United States
(12) Patent Application Publication
(10) Pub. No.: US 2025/0382223 A1
(43) Pub. Date: Dec. 18, 2025

(54) PHOSPHOR DEVICE

(71) Applicant: Panasonic Intellectual Property Management Co., Ltd., Osaka (JP)

(72) Inventors: Yukihiko SUGIO, Osaka (JP); Naoyuki TANI, Osaka (JP); Shunsuke WATANABE, Kyoto (JP); Koji TOMIMORI, Nara (JP); Yasushi YOSHIDA, Osaka (JP); Yoshiyuki TAKAHIRA, Kyoto (JP); Takumi OKUDA, Kyoto (JP); Masashi UCHIDA, Osaka (JP); Masayuki SUIZU, Kyoto (JP); Yoshihiro MURAGAKI, Osaka (JP); Kenta NAKAMOTO, Osaka (JP)

(73) Assignee: Panasonic Intellectual Property Management Co., Ltd., Osaka (JP)

(21) Appl. No.: 19/101,378

(22) PCT Filed: Jan. 18, 2023
(86) PCT No.: PCT/JP2023/001394

§ 371 Date: Feb. 5, 2025

(30) Foreign Application Priority Data
Aug. 31, 2022 (JP) 2022-137378

(51) Int. Cl. C03C 17/36; F21V 9/30; G03B 21/20

(52) U.S. Cl. CPC C03C 17/3668; C03C 17/3644; C03C 2217/213; C03C 2217/218; C03C 2217/256; C03C 2217/734; F21V 9/30; G03B 21/204

(57) ABSTRACT

A phosphor device includes: a substrate; a phosphor layer including pores; a reflection layer between the substrate and the phosphor layer; a joint layer between the substrate and the reflection layer, the joint layer containing a first metal; and a metal layer between the reflection layer and the joint layer, the metal layer containing a second metal having a melting point higher than a melting point of the first metal. The reflection layer has a multilayer structure obtained by alternately stacking a high-refractive layer and a low-refractive layer having a refractive index smaller than a refractive index of the high-refractive layer.

### TECHNICAL FIELD

The present invention relates to a phosphor device.

### BACKGROUND ART

A wavelength conversion element is typically known which contains phosphor that emits fluorescence upon receipt of laser light emitted from a laser source (see, e.g., Patent Literatures (PTLs) 1 to 3). The wavelength conversion element disclosed in PTLs 1 to 3 includes a substrate, a phosphor layer, and a reflection layer between the substrate and the phosphor layer.

### CITATION LIST

### Patent Literature

[PTL 1] Japanese Patent No. 6536212
[PTL 2] Japanese Unexamined Patent Application Publication No. 2022-41839
[PTL 3] Japanese Patent No. 6499381

### SUMMARY OF INVENTION

### Technical Problem

In the background art, there is a room for increasing the reliability of the substrate supporting the reflection layer and the phosphor layer.

It is an objective of the present invention to provide a highly reliable phosphor device.

### Solution to Problem

A phosphor device according to an aspect of the present invention includes: a substrate; a phosphor layer including pores; a first reflection layer between the substrate and the phosphor layer; a joint layer between the substrate and the first reflection layer, the joint layer containing a first metal; and a metal layer between the first reflection layer and the joint layer, the metal layer containing a second metal having a melting point higher than a melting point of the first metal. The first reflection layer has a multilayer structure a multilayer structure in which a high-refractive layer a low-refractive layer are alternately stacked, the low-refractive layer having a refractive index smaller than a refractive index of the high-refractive layer.

### Advantageous Effects of Invention

The present invention can provide a highly reliable phosphor device.

### BRIEF DESCRIPTION OF DRAWINGS

FIG. 1 is a cross-sectional view of a phosphor device according to Embodiment 1.

FIG. 2 shows an SEM image of a phosphor layer of the phosphor device according to Embodiment 1 in a cross section.

FIG. 3 shows an SEM image of a joint layer of the phosphor device according to Embodiment 1 in a cross section.

FIG. 4 shows an image obtained by binarizing an SEM image of the phosphor layer of the phosphor device according to Embodiment 1 in a cross section.

FIG. 5 shows the relationship between the porosity and the density of the phosphor layer.

FIG. 6 illustrates the reliability of the phosphor device according to Embodiment 1.

FIG. 7 is a cross-sectional view of a phosphor device according to Embodiment 2.

FIG. 8 shows the dependency of the reflectance on the incident angle in the stack structure of the first reflection layer and the second reflection layer in the phosphor device according to Embodiment 2.

FIG. 9 illustrates the advantage of the first reflection layer in reducing stress in the phosphor device according to each embodiment.

### DESCRIPTION OF EMBODIMENTS

Now, a phosphor device according to an embodiment of the present invention will be described in detail with reference to the drawings. The embodiments described below are mere specific examples of the present invention. The numerical values, shapes, materials, elements, the arrangement and connection of the elements, steps, step orders etc. shown in the following embodiments are thus mere examples, and are not intended to limit the scope of the present invention. Among the components in the following embodiments, those not recited in the independent claims will be described as optional.

The figures are schematic representations and not necessarily drawn strictly to scale. The scales are thus not necessarily the same in the figures. The same reference signs represent substantially the same configurations in the drawings and redundant description will be omitted or simplified.

In this specification, the terms, such as “parallel”, representing the relationships between the components, the terms such as “circular” or “rectangular” representing the shapes of the components, and the numerical ranges are expressions of not only strict meanings but substantially equivalent ranges including differences of several percents.

In this specification, the terms “above” and “below” do not refer to the upper direction (i.e., “vertically upward”) and the lower direction (i.e., “vertically downward”) in absolute spatial recognition, but are defined by the relative positional relationships based on the stacking order of the stack structure. In the following description, the term “above” represents the direction in which the phosphor layer is located relative to the substrate and “below” represents the opposite. The terms “above” and “below” are employed not only when two components are spaced apart with another component interposed therebetween, but also when two elements are in close contact with each other.

In this specification, the expression “A contains B as a main component” means that the content of B in A is greater than 50%. At this time, the content of B may be 60% or more, 70% or more, 80% or more, 90% or more, 95% or more, 99% or more, or 100%. If the content of B in A is 100%, A may contain impurities unavoidable at the time of manufacturing. That is, the content 100% means that the purity of B is high enough to be considered as 100%.

In this specification, ordinal numbers, such as “first” and “second”, do not mean the number or order of components, unless otherwise specified, but are used for the purpose of avoiding confusion and distinguishing components of the same type.

### Embodiment 1

### [Configuration]

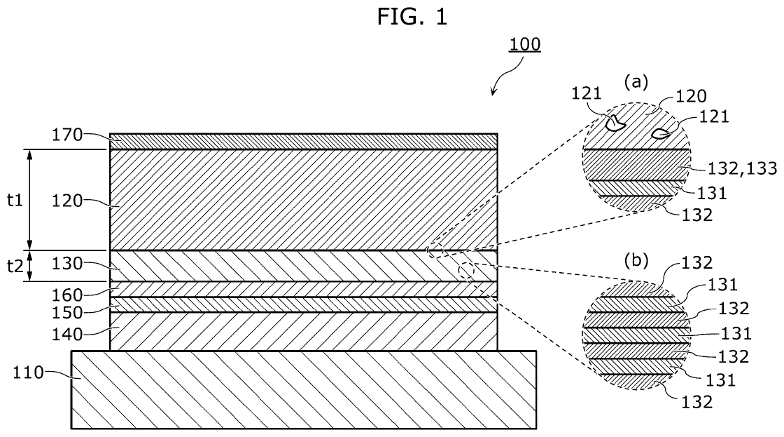

First, an outline of a phosphor device according to Embodiment 1 will be described with reference to FIG. 1. FIG. 1 is a cross-sectional view of phosphor device 100 according to this embodiment.

Phosphor device 100 shown in FIG. 1 contains a phosphor that emits fluorescence when excited by light from an excitation light source (not shown). Phosphor device 100 is used as a projector or a light source unit (or a light-emitting unit) for lighting equipment, for example. For example, an optical system (not shown) including a lens or an aperture is placed on the fluorescence-emitting side of phosphor device 100. Via the optical system, fluorescence or fluorescence and reflected excitation light can be emitted in a desired direction via an optical system.

Examples of the excitation light source include a semiconductor laser device and a light emitting diode (LED). The excitation light source is not limited thereto. As an example, the excitation light source is a blue laser element that emits blue light. Note that the excitation light source may be visible light (e.g., violet light) other than blue light or may be ultraviolet light.

As shown in FIG. 1, phosphor device 100 includes substrate 110, phosphor layer 120, reflection layer 130, joint layer 140, metal layer 150, protection layer 160, and anti-reflection film 170. On substrate 110; joint layer 140, metal layer 150, protection layer 160, reflection layer 130, phosphor layer 120, and anti-reflection film 170 are stacked in this order. Note that protection layer 160 and anti-reflection film 170 are not necessarily provided.

Substrate 110 is a support member that supports phosphor layer 120. Substrate 110 also functions as a heat dissipation member (i.e., a heat spreader) that dissipates the heat generated when excitation light is irradiated. For example, substrate 110 is made of a high thermal conductivity material. This configuration can improve the heat dissipation of substrate 110, which increases the wavelength conversion efficiency of phosphor layer 120 and the reliability. Examples of the high thermal conductivity material include metal, such as copper (Cu). For example, a copper plate with a laminated film of gold (Au) and nickel (Ni) plated on the surface can be used as substrate 110.

Phosphor layer 120 is excited by excitation light and emits fluorescence. In this embodiment, phosphor layer 120 contains a yellow phosphor that emits yellow light upon receipt of blue light as excitation light. A yellow phosphor has a peak wavelength within a range from 380 nm to 490 nm in the excitation spectrum, and a peak wavelength within a range from 490 nm to 580 nm in the fluorescence spectrum. Phosphor device 100 can emit white light as a mixture of the yellow light emitted from the yellow phosphor and the blue light that is the excitation light.

As an example, the yellow phosphor has a cerium-activated garnet structure, such as YAG, but not limited thereto. Phosphor layer 120 contains one type of phosphor, for example. The number of types is not limited thereto. Phosphor layer 120 may contain a plurality of types of phosphor. For example, phosphor layer 120 may contain at least one of a green phosphor or a red phosphor in addition to or in place of the yellow phosphor. For example, phosphor layer 120 may contain a green phosphor, such as LuAG or a red phosphor, such as CASN or SCASN. By adjusting the type(s) of phosphor contained in phosphor layer 120, phosphor device 100 can emit light in a desired color.

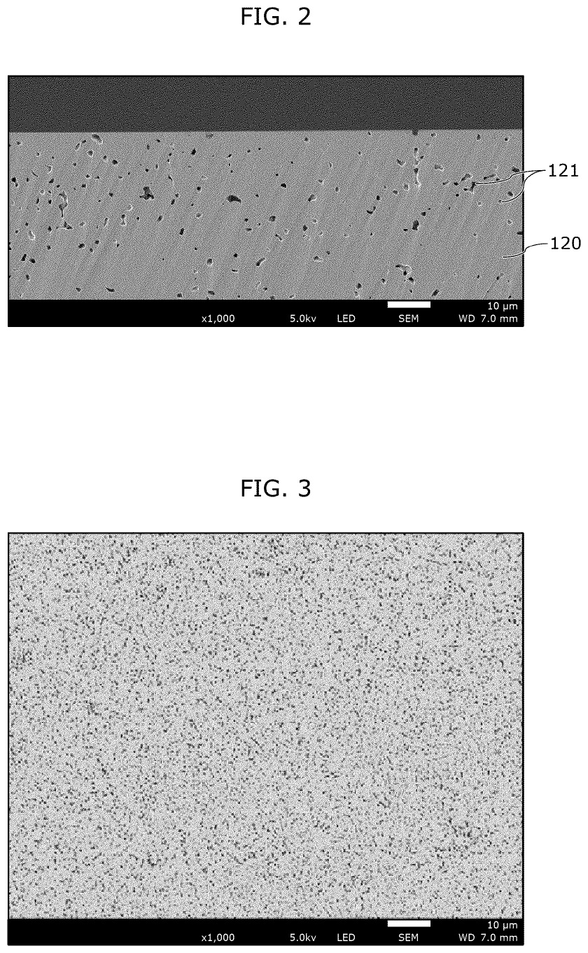

In this embodiment, phosphor layer 120 is a sintered body of a phosphor, that is, ceramic. As shown in (a) of FIG. 1 and FIG. 2, phosphor layer 120 includes pores 121.

Here, (a) of FIG. 1 is a schematic enlarged representation of a cross section near the interface between phosphor layer 120 and reflection layer 130. FIG. 2 shows a scanning electron microscope (SEM) image of phosphor layer 120 in phosphor device 100 according to this embodiment in a cross section. As shown in FIG. 2, pores 121 are dispersed and present inside phosphor layer 120.

Present pores 121 can scatter the excitation light incident on phosphor layer 120 and generated fluorescence. The percentage (hereinafter referred to as “porosity”) of pores 121 in phosphor layer 120 is within a range from 1% to 9%, for example. How to measure the porosity will be described later.

If there are no pores 121 at all, phosphor layer 120 functions as a light guide plate and spreads the area of the light emitting spot. A porosity of 1% or more can reduce the spread of the light emitting spot by properly scattering light. This configuration can increase the light incidence efficiency (i.e., the light intake efficiency of the optical system) of the fluorescence emitted from the light emitting spot on the optical system (not shown). A porosity of 9% or less can sufficiently secure the phosphor that emits fluorescence, which causes less decrease in the luminous efficiency. In this manner, by adjusting the porosity, both a higher efficiency of the light incident on the optical system and less decrease in the luminous efficiency can be achieved.

The main surface of phosphor layer 120, which is in parallel with the main surface of substrate 110, has an area within a range from 1.5 mm² to 36 mm² as an example. For example, an area of 1.5 mm² or more can secure a light emitting spot in a certain size or more, without limiting the spread of the light emitting spot. This configuration can secure a large heat dissipation area on the back surface, which is closer to substrate 110, of phosphor layer 120, thereby improving the heat dissipation. The main surface of phosphor layer 120 with an area of 36 mm² or less can reduce an excessive spread of the light emitting spot. This configuration can increase the light incidence efficiency of the fluorescence emitted from the light emitting spot on the optical system (not shown) (i.e., the light intake efficiency of the optical system). In this manner, by adjusting the area of the main surface of phosphor layer 120, both an improved heat dissipation and a higher efficiency of the light incident on the optical system can be achieved.

Note that the main surface of phosphor layer 120 is in a circular shape in plan view, for example. The shape is however not limited thereto. The main surface of phosphor layer 120 may be in the shape of a quadrilateral shape, such as a square or a rectangular, or in an annular shape with a predetermined width in plan view.

Phosphor layer 120 has thickness t1 within a range from 20 μm to 150 μm, for example. Thickness t1 of 20 μm or more can increase the mechanical strength of phosphor layer 120. Thickness t1 of 150 μm or less can reduce the distance between the light incident surface, which is closer to anti-reflection film 170, of phosphor layer 120 and substrate 110. This can efficiently transfer the heat generated near the light incident surface to substrate 110. Accordingly, the heat dissipation of phosphor layer 120 can improve. Thickness t1 of 150 μm or less can reduce excessive spread of the light emitting spot. This configuration can increase the light incidence efficiency of the fluorescence emitted from the light emitting spot on the optical system (not shown) (i.e., the light intake efficiency of the optical system). In this manner, by adjusting thickness t1 of phosphor layer 120, a higher mechanical strength, an improved heat dissipation, and a higher light incidence efficiency on the optical system can be achieved.

Although not shown in FIGS. 1 and 2, there may be phosphors in a size smaller than the size of the phosphor forming the body of phosphor layer 120, in recesses in the main surface of phosphor layer 120. This configuration can increase the flatness of the main surface of phosphor layer 120. A higher flatness can improve the film qualities of anti-reflection film 170 and reflection layer 130. This configuration can achieve a higher transmittance of anti-reflection film 170 and a higher reflectance of reflection layer 130.

In this embodiment, phosphor layer 120 does not contain any binding agent, such as a binder.

Reflection layer 130 is an example of the “first reflection layer” between substrate 110 and phosphor layer 120. Specifically, reflection layer 130 is in contact with phosphor layer 120. More specifically, reflection layer 130 is in contact with and covers almost the entire area of the main surface, which is closer to substrate 110, of phosphor layer 120. This configuration can increase the adhesiveness between reflection layer 130 and phosphor layer 120, reduce the peeling of reflection layer 130, and increase the reliability of phosphor device 100.

Reflection layer 130 reflects the fluorescence emitted from phosphor layer 120. Reflection layer 130 also reflects the excitation light transmitted through phosphor layer 120. As shown in (b) of FIG. 1, reflection layer 130 has a multilayer structure obtained by alternately stacking high-refractive layer 131 and low-refractive layer 132. Here, (b) of FIG. 1 is a schematic enlarged view of a cross-sectional structure of reflection layer 130. In this embodiment, one high-refractive layer 131 and one low-refractive layer 132 are alternately and tightly stacked one on the other.

High-refractive layers 131 have a refractive index greater than the refractive index of low-refractive layers 132. Specifically, high-refractive layers 131 are made of a dielectric material with a great refractive index.

Each high-refractive layer 131 is a Nb₂O₅ layer, for example, containing niobium oxide (Nb₂O₅) as a main component. Nb₂O₅ layer has a refractive index of about 2.3. The Nb₂O₅ has a lower melting point than the melting points of other high-refractive oxide materials (e.g., TiO₂ or Ta₂O₅). Accordingly, high-refractive layers 131 can be formed, which are less distorted in vapor deposition, for example, or have excellent film quality. This configuration can improve the optical characteristics (e.g., reflectance and design accuracy of reflection wavelength) of reflection layer 130. Note that high-refractive layers 131 may contain TiO₂ or Ta₂O₅ as a main component.

Low-refractive layers 132 have a refractive index smaller than the refractive index of high-refractive layers 131. Specifically, low-refractive layers 132 are made of a dielectric material with a small refractive index.

Each Low-refractive layer 132 is a SiO₂ layer, for example, containing silicon dioxide (SiO₂) as a main component. The SiO₂ layer has a refractive index of about 1.5. Note that low-refractive layers 132 may contain MgF₂ or CaF₂ as a main component.

In this embodiment, as shown in (a) of FIG. 1, one of low-refractive layers 132 is the uppermost layer of reflection layer 130 and is in contact with phosphor layer 120. This low-refractive layer 132 as the uppermost layer functions as planarization layer 133 with a thickness larger than the thickness of other low-refractive layers 132. Provided planarization layer 133 can reduce the surface roughness of phosphor layer 120 and improve the film qualities (e.g., the flatnesses) of high-refractive layers 131 and low-refractive layers 132.

By adjusting the materials (i.e., refractivities), the thickness and the number of high-refractive layers 131 and low-refractive layers 132, the reflectance, the reflection wavelength range, and other parameters of reflection layer 130 can be adjusted. In this embodiment, reflection layer 130 is configured to reflect the blue light (i.e., the excitation light) and the yellow light (i.e., the fluorescence) efficiently. Reflection layer 130 may reflect light over the entire bandwidth of visible light at a high efficiency.

The total number of high-refractive layers 131 and low-refractive layers 132 is three or more. For example, the total number may be 10 or more, 20 or more, 30 or more, 40 or more, and 50 or more.

In this embodiment, thickness t2 of reflection layer 130 is 1.0% or more of thickness t1 of phosphor layer 120. This configuration can increase the mechanical strength of reflection layer 130 and reduce the peeling or other problems of the layer. In addition, thickness t2 of reflection layer 130 is less than 10% of thickness t1 of phosphor layer 120. Reflection layer 130 with a not-too-large thickness can reduce the stress and the peeling or warpage of phosphor layer 120.

Reflection layer 130 has thickness t2 within a range from 500 nm to 8000 nm, for example. Thickness t2 of 500 nm or more can increase the mechanical strength of reflection layer 130. The thickness can reduce the peeling at the interface with phosphor layer 120. The thickness can reduce the surface roughness of phosphor layer 120 and improve the film qualities (e.g., the flatnesses) of high-refractive layers 131 and low-refractive layers 132. The thickness can reduce the diffusion of the metal material contained in joint layer 140. In this manner, thickness t2 of 500 nm or more can increase the reliability of phosphor device 100. Thickness t2 may be 1500 nm or more. This thickness can greatly exhibit the advantages of increasing the mechanical strength, reducing the peeling, improving the film quality, and reducing the diffusion of the metal material, for example.

Reflection layer 130 with thickness t2 of 8000 nm or less can efficiently transfer the heat generated in phosphor layer 120 to substrate 110. Accordingly, the heat dissipation of phosphor layer 120 can improve. In this manner, by adjusting thickness t2 of reflection layer 130, a higher mechanical strength, a higher reliability and an improved heat dissipation can be achieved.

Joint layer 140 is interposed between substrate 110 and reflection layer 130. Specifically, joint layer 140 is in contact with the main surface, which is closer to phosphor layer 120, of substrate 110. Joint layer 140 is provided for joining phosphor layer 120 and reflection layer 130 to substrate 110.

Joint layer 140 contains a first metal. Specifically, joint layer 140 contains the first metal as a main component. Joint layer 140 has a single layer structure of the first metal. The first metal is silver (Ag) or copper (Cu).

FIG. 3 shows an SEM image of joint layer 140 in phosphor device 100 according to this embodiment in a cross section. As shown in FIG. 3, joint layer 140 includes a large number of pores. Note that the black dots in FIG. 3 correspond to the pores. The effects and advantages of including the pores in joint layer 140 will be described later.

Metal layer 150 is interposed between reflection layer 130 and joint layer 140. In this embodiment, metal layer 150 is interposed between protection layer 160 and joint layer 140. Metal layer 150 is in contact with the main surface, which is closer to phosphor layer 120, of joint layer 140.

Metal layer 150 contains a second metal. Specifically, metal layer 150 contains the second metal as a main component. The second metal has a melting point higher than the melting point of the first metal. Examples of the second metal includes chromium (Cr), nickel (Ni), palladium (Pd), or tungsten (W), for example. Metal layer 150 may have a stack structure of a plurality of different metal layers or a single layer structure. Metal layer 150 may be made of the second metal alone or an alloy with another metal element.

Metal layer 150 is for assisting the joining of joint layer 140. Specifically, metal layer 150 contains the second metal with a higher melting point than the melting point of the first metal, thereby increasing the adhesiveness between joint layer 140 and protection layer 160 (and reflection layer 130 if there is no protection layer 160). Note that metal layer 150 functions as a barrier metal (i.e., a metal protection layer) that reduces the diffusion of the first metal from joint layer 140. On the other hand, metal layer 150 also functions as a barrier metal that reduces the entry of impurities, such as oxygen, into joint layer 140.

Protection layer 160 is interposed between reflection layer 130 and metal layer 150. Protection layer 160 is in contact with each of the main surface, which is closer to substrate 110, of reflection layer 130 and the main surface, which is closer to phosphor layer 120, of metal layer 150.

Protection layer 160 contains a dielectric material as a main component. Examples of protection layer 160 include aluminum oxide (Al₂O₃) and silicon dioxide (SiO₂). Protection layer 160 may have a single layer structure of a dielectric layer or a stack structure of a plurality of dielectric layers. The stack structure may include a metal layer, for example.

Provided protection layer 160 can reduce the stress caused by the difference in the thermal expansion coefficient between reflection layer 130 and metal layer 150 and reduce the peeling or other problems of the layer. Protection layer 160 can reduce the diffusion of the first metal from joint layer 140 into reflection layer 130. Protection layer 160 can also reduce the entry of the oxygen and ions into reflection layer 130 and a change in the film quality of reflection layer 130. This configuration can reduce a decrease in the reliability, such as the reflectance.

Anti-reflection film 170 is an AR coat layer for reducing the reflection of the excitation light from an excitation light source (not shown). Anti-reflection film 170 has a high transmittance of excitation light and fluorescence. Anti-reflection film 170 is in contact with and covers the main surface, which is farther from substrate 110, of phosphor layer 120. For example, anti-reflection film 170 has a single layer structure of a dielectric layer or a stack structure. Examples of the dielectric layer included in anti-reflection film 170 include a TiO₂ layer, a Nb₂O₅ layer, and a SiO₂ layer. The layer is however not limited thereto.

### [Pores of Phosphor Layer]

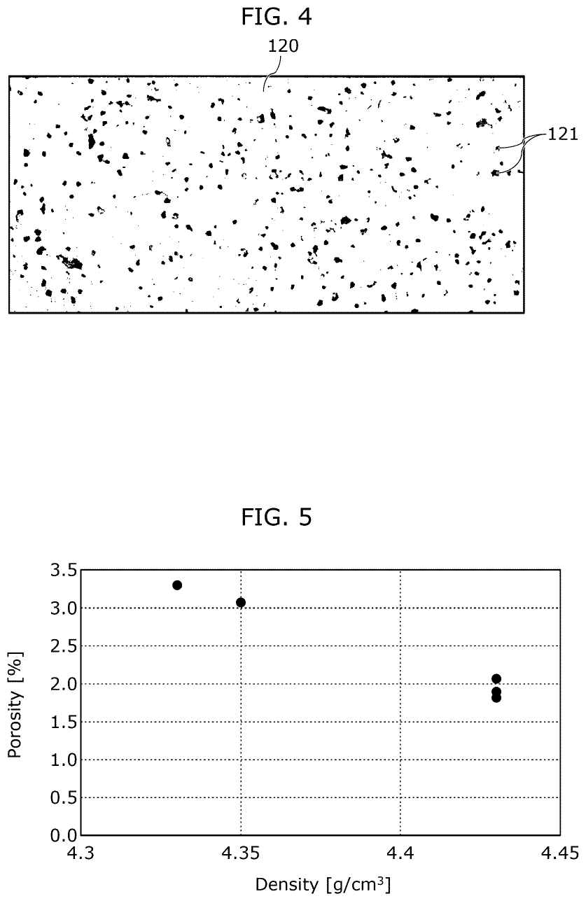

Next, how to measure the porosity of phosphor layer 120 will be described with reference to FIG. 4. FIG. 4 shows an image obtained by binarizing an SEM image of phosphor layer 120 in a cross section.

The porosity is calculated with the total area of pores 121 appearing on the cross section of phosphor layer 120 regarded as the percentage of the cross-sectional area of phosphor layer 120. Specifically, as shown in FIG. 4, the SEM image in a freely selected cross section of phosphor layer 120 is binarized by imaging processing. This binarization can easily distinguish pores 121 from the main body (i.e., the phosphor part) of phosphor layer 120. In the binarized image, the porosity can be calculated by calculating the cross-sectional area of phosphor layer 120 (i.e., the total area including the phosphor and pores 121) and the total area of pores 121.

In order to reduce the variations in the porosity to be obtained, the value obtained by averaging the porosities calculated in a plurality of cross sections may be calculated as the porosity of phosphor layer 120.

FIG. 5 shows the relationship between the porosity and the density of phosphor layer 120. In FIG. 5, the horizontal axis represents the density (unit: g/cm³), and the vertical axis represents porosity (unit: %). It can be seen from FIG. 5 that the porosity and the density have a negative correlation.

Each plot shown in FIG. 5 represents the actually measured values of the porosity and the density of each of Samples 1 to 3 of phosphor layer 120 prepared by the inventors. Table 1 shows specific values of the porosity and the density.

TABLE 1

| | Density | Porosity |
|---|---|---|
| No. | [g/cm³] | [%] |
| 1 | 4.33 | 3.30 |
| 2 | 4.35 | 3.08 |
| 3 | 4.43 | 1.82 |
| | | 2.06 |
| | | 1.9 |
| | | 1.87 |

Sample 3 shows the results of calculating the porosities in four different cross sections. It can be seen from Table 1 that the porosity lowers with an increase in the density as compared to Samples 1 and 2, although there are variations between 1.82% and 2.06%.

From the foregoing, the value of porosity can be estimated based on the density of phosphor layer 120. For example, phosphor layer 120 according to this embodiment has a density within a range from 3.80 g/cm³ to 4.55 g/cm³, for example.

### [Pores of Joint Layer]

Next, the effects and advantages provided by the pores in joint layer 140 will be described.

As shown in FIG. 3, there are a large number of pores in joint layer 140. In general, if a large number of pores in large sizes are present in joint layer 140, the mechanical joint strength decreases and the heat dissipation deteriorates. For example, used as phosphor device 100 according to this embodiment is a device for excitation through laser irradiation, which is of a non-rotary type with no cooling effect caused by rotation. Efficiently dissipating the heat generated from phosphor layer 120 from joint layer 140 to substrate 110 is thus important. In this case, a decrease in the percentage of the pores in joint layer 140 can improve the heat dissipation and increase the limit of inputtable blue laser power. An increase in the limit of inputtable blue laser power provides a high light output.

In phosphor device 100 according to this embodiment, joint layer 140 has a porosity of 20% or less. Joint layer 140 with a porosity of 20% or less provides an excellent heat dissipation. With an improved heat dissipation, even if phosphor layer 120 has a large thickness and generates a larger amount of heat, the light conversion efficiency is less reduced by the temperature characteristics of the phosphor and a wider thickness range of phosphor layer 120 can be set. Phosphor layer 120 with a greater thickness increases the absorption rate of blue laser, increases light conversion efficiency, and provides a high light output.

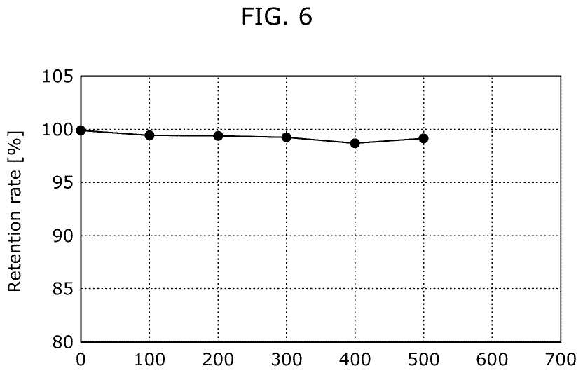

FIG. 6 illustrates the reliability of phosphor device 100 according to this embodiment. In FIG. 6, the horizontal axis represents the time (unit: h) elapsed after the start of laser irradiation, and the vertical axis represents the retention rate of the fluorescence output of the phosphor device.

FIG. 6 shows a change in the fluorescence output of the phosphor device when continuously projecting blue laser light on a sample of phosphor device 100 including joint layer 140 with a porosity of 20%. The vertical axis represents the fluorescence output retention rate where the phosphor device has a fluorescence output of 100% at the initial stage (i.e., at the start of laser irradiation). As shown in FIG. 6, even after the elapse of 500 h, the retention rate remains about 99%. That is, it can be seen that phosphor device 100 with a long life and a high reliability is achieved.

The relationship between the thickness and the input limit power of joint layer 140 will be described with reference to Table 2. Table 2 shows the thickness and a relative value of the input limit power of joint layer 140 with a porosity of 20%. Note that the relative value represents the input limit power relative to an input limit power of 100% where joint layer 140 has a thickness of 30 μm at the initial stage.

As shown in Table 2, no decrease in the input limit power was observed where joint layer 140 has a thickness within a range from 30 μm to 125 μm. A decrease in the input limit power was observed once the thickness of joint layer 140 exceeds 150 μm. A larger thickness of joint layer 140 can provide the advantages of reducing the stress onto phosphor layer 120 and thus reduce a crack or other problems of phosphor layer 120.

TABLE 2

| | Thickness of Joint Layer | Absolute Value of |
|---|---|---|
| No. | [μm] | Input Limit Power [%] |
| 1 | 30 | 100 |
| 2 | 50 | 100 |
| 3 | 65 | 100 |
| 4 | 100 | 100 |
| 5 | 125 | 100 |
| 6 | 150 | 89 |

### Embodiment 2

Next, Embodiment 2 will be described.

A phosphor device according to Embodiment 2 is different from that in Embodiment 1 in including a second reflection layer. In the following, the differences from Embodiment 1 will be mainly described and the description of the common matters will be omitted or simplified.

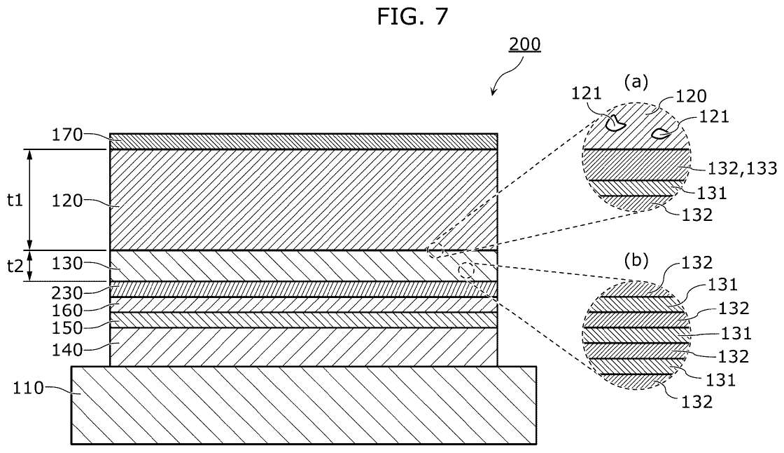

FIG. 7 is a cross-sectional view of phosphor device 200 according to this embodiment. As shown in FIG. 7, phosphor device 200 is different from phosphor device 100 according to Embodiment 1 in further including reflection layer 230.

Reflection layer 230 is an example of the “second reflection layer” and has reflection characteristics different from the reflection characteristics from reflection layer 130. Reflection layer 230 is interposed between reflection layer 130 and joint layer 140. Specifically, reflection layer 230 is interposed between reflection layer 130 and metal layer 150. More specifically, reflection layer 230 is interposed between reflection layer 130 and protection layer 160. For example, the upper surface of reflection layer 230 is in contact with the lower surface of reflection layer 130. The lower surface of reflection layer 230 is in contact with the upper surface of protection layer 160. The thickness of reflection layer 230 is not particularly limited but may fall within a range from 10 nm to 1500 nm, for example.

Reflection layer 230 is a metal reflection layer containing metal as a main component. Specifically, reflection layer 230 is made of a metal material, such as Ag, Al, Rh, Pd, Cr, Sn, and Zn, alone or an alloy. For example, reflection layer 230 may be a mirror layer made of an alloy of Ag, Pd, and Cu (APC). With the use of an APC mirror layer as reflection layer 230, a high reflectance and a high corrosion durability can be achieved.

Reflection layer 230 may be made of the above-mentioned metal alone or a multilayer of an alloy, or may have a mixed structure with a metal oxide, such as Al₂O₃, SnOx, or ZnOx, obtained by oxidizing the above-mentioned metal alone. For example, a layer of (mixture of ZnO/Zn)/Ag or a layer of (mixture of SnO/Sn)/Ag is conceivable as reflection layer 230. In addition, reflection layer 230 may be a layer of (mixture of Al₂O₃/Al)/(mixture of ZnO/Zn)/Ag or a layer of (mixture of Al₂O₃/Al)/(mixture of SnO/Sn)/Ag. The multilayer structure increases the reliability.

Phosphor device 200 according to this embodiment has the stack structure of reflection layers 130 and 230 and can thus efficiently reflect obliquely incident light. That is, reflection layers 130 and 230 are provided for reducing the dependency of the reflectance on the incident angle and achieving a stable reflectance.

The excitation light for exciting phosphor layer 120 is usually incident on phosphor device 200 at a small incident angle. Here, the incident angle is the angle of the light incident on the upper surface (i.e., the interface with anti-reflection film 170) of phosphor layer 120. For example, the excitation light is incident on phosphor layer 120 at an incident angle smaller than 10°.

Phosphor layer 120 however includes pores 121 as shown in FIG. 2. Even excitation light incident at a small incident angle is reflected into various directions while being propagated inside phosphor layer 120. The excitation light may thus be incident on reflection layer 130 at a large incident angle. The same applies to fluorescence generated inside phosphor layer 120.

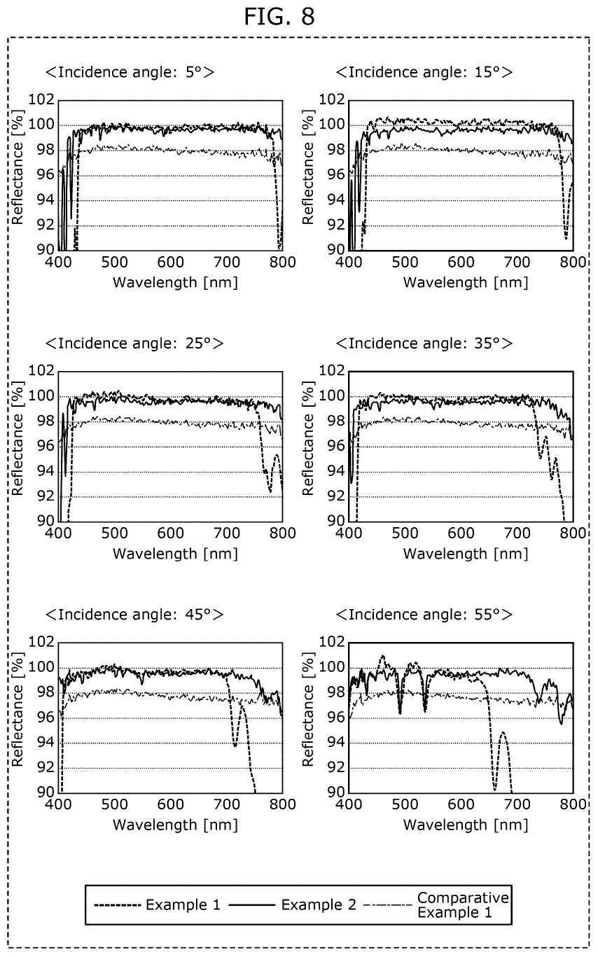

Now, the dependency of the reflectance on the incident angle in reflection layer 130 will be described with reference to FIG. 8. FIG. 8 shows the dependency of the reflectance on the incident angle in the stack structure of reflection layers 130 and 230 of phosphor device 200 according to this embodiment.

The six graphs in FIG. 8 show the wavelength-dependency of the reflectance in each of the three samples of Example 1, Example 2, and Comparative Example 1. The six graphs represent the cases where the light is projected onto the samples at incident angles of 5°, 15°, 25°, 35°, 45°, and 55°. In Example 1, reflection layer 130 is formed on a dummy glass substrate, which corresponds to Embodiment 1. In Example 2, reflection layer 130 and reflection layer 230 are stacked on a dummy glass substrate, which corresponds to Embodiment 2. In Comparative Example 1, a high-reflection layer and reflection layer 230 are stacked on a dummy glass substrate. Note that the high-reflection layer is obtained by stacking four or five layers of high-refractive layers and low-refractive layers. None of the samples includes phosphor layer 120.

As can be seen from FIG. 8, the reflectivities are kept higher in Examples 1 and 2 than in Comparative Example 1, regardless of the magnitude of the incident angle within a range from 430 nm to about 650 nm. That is, reflection layer 130 alone or the stack structure of reflection layers 130 and 230 provides a high reflectance.

On the other hand, the following tendency is found within a long bandwidth. With an increase in the incident angle, the reflectance of Example 1 decreases. For example, at an incident angle of 55°, the reflectance of Example 1 decreases within a range of about 650 nm or more.

By contrast, it is found that, in Example 2, there is a slight decrease in the reflectance is observed but a high reflectance can be kept as compared to Example 1 with an increase in the incident angle. It is thus found that reflection layer 230 provided in addition to reflection layer 130 can reflect the light of a wavelength component not reflected by reflection layer 130.

From the foregoing, phosphor device 200 according to this embodiment can reduce the dependency of the reflectance on the incident angle and maintain a high reflectance in a bandwidth of visible light.

### [Reduction in Stress]

Now, the advantage of reflection layer 130 in reducing the stress in phosphor devices 100 and 200 according to Embodiments 1 and 2 will be described.

As shown in FIGS. 1 and 7, each of phosphor devices 100 and 200 includes planarization layer 133 on the lower surface of phosphor layer 120. Planarization layer 133 can reduce the surface roughness of phosphor layer 120 and improve the film qualities (e.g., the flatnesses) of high-refractive layers 131 and low-refractive layers 132. Planarization layer 133 is a part of reflection layer 130. In other words, planarization layer 133 is the closest layer to phosphor layer 120 (specifically, the uppermost layer) in the multilayer structure of reflection layer 130.

Planarization layer 133 has a larger thickness than other low-refractive layers 132 so as to reduce the surface roughness of phosphor layer 120. Thus, in order to increase the reliability of each phosphor device 100, 200, there is a need to reduce the stress caused by planarization layer 133. This reduction in the stress is performed by the multilayer structure of reflection layer 130.

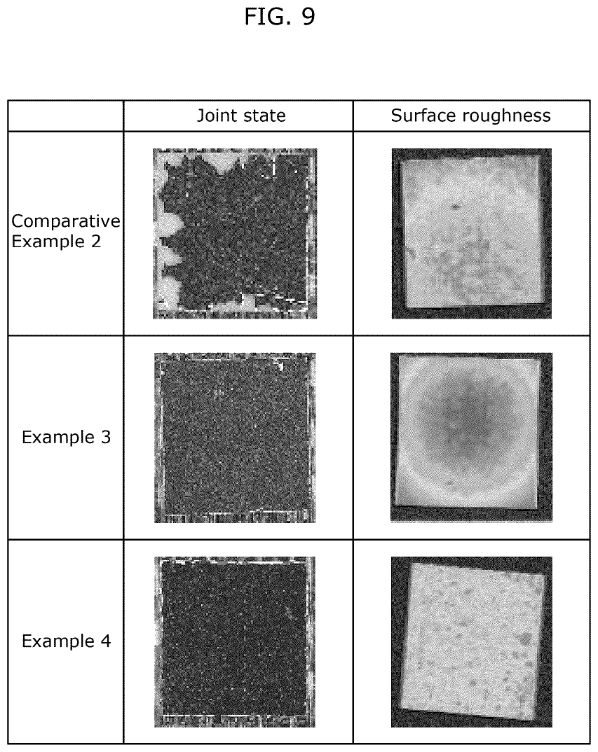

FIG. 9 illustrates the advantage of reflection layer 130 in reducing the stress in phosphor device 100, 200 according to each embodiment. FIG. 9 shows the joint state between phosphor layer 120 and substrate 110, and the result of measuring the surface roughness of phosphor layer 120 in the three examples of Comparative Example 2, Example 3, and Example 4.

Comparative Example 2 includes a silicon dioxide film with a thickness of 1 μm in place of reflection layer 130. Example 3 includes, as reflection layer 130, a multilayer structure of a Nb₂O₅ layer and a SiO₂ layer, with a thickness of 3 μm, which corresponds to Embodiment 1. Example 4 includes, as reflection layers 130 and 230, a multilayer structure of a Nb₂O₅ layer and a SiO₂ layer, and a thin Ag film, with a thickness of 1 μm, which corresponds to Embodiment 2.

The joint states are shown in FIG. 9 in photographs obtained by capturing the samples from the front. In Comparative Example 2, the ends (i.e., the white portions) of the sample are peeled. That is, it is found that Comparative Example 2 fails to sufficiently secure the adhesiveness between phosphor layer 120 and substrate 110. On the other hand, in Examples 3 and 4, the multilayer structure reduces the stress, resulting in less peeling of phosphor layer 120 and a high adhesiveness.

The surface roughness is shown in FIG. 9 as a result of measuring the height of the surface in each sample, using VR measuring instrument. The depth of the gray color represents the height. It is found that the comparative examples have a tendency that the top and bottom are at different heights and warpage occurs. It is found that Example 3 has a tendency that the central area and four corners are at different heights and warpage occurs. That is, a too-large thickness of the multilayer structure secures the adhesiveness but causes the warpage. On the other hand, it is found that Example 4 has a height uniform throughout the entire area and no warpage occurs. In this manner, reflection layer 130 with the multilayer structure and reflection layer 230 being a thin metal film achieve both the adhesiveness and less warpage.

### Summary

As described above, the phosphor device according to a first aspect of the present invention is, for example, phosphor device 100 or 200 described above. The phosphor device includes: substrate 110; phosphor layer 120 including pores 121; reflection layer 130 between substrate 110 and phosphor layer 120; joint layer 140 between substrate 110 and reflection layer 130, the reflection layer containing a first metal; and metal layer 150 between reflection layer 130 and joint layer 140, the metal layer containing a second metal having a melting point higher than a melting point of the first metal. Reflection layer 130 has a multilayer structure obtained by alternately stacking high-refractive layer 131 and low-refractive layer 132 having a refractive index smaller than a refractive index of high-refractive layer 131.

This configuration increases the adhesiveness between joint layer 140 and metal layer 150. Phosphor layer 120 and reflection layer 130 become less likely to peel off substrate 110. In this manner, this aspect can provide highly reliable phosphor device 100 or 200.

For example, a phosphor device according to a second aspect of the present invention is an embodiment of the phosphor device according to the first aspect. Phosphor layer 120 is made of ceramic.

This configuration facilitates the formation of phosphor layer 120 including pores 121. Functioning as a light scattering element, pores 121 can reduce the lateral propagation inside light within phosphor layer 120. This configuration can reduce the spread of the light emitting spot and increase the efficiency of the light incident on the optical system (not shown).

For example, a phosphor device according to a third aspect of the present invention is an embodiment of the phosphor device according to the first or second aspect. Phosphor layer 120 and reflection layer 130 are in contact with each other.

This can increase the adhesiveness between reflection layer 130 and phosphor layer 120 and reduce the peeling of reflection layer 130. Accordingly, the reliability of the phosphor device according to this aspect can increase.

For example, a phosphor device according to a fourth aspect of the present invention is an embodiment of the phosphor device according to any one of the first to third aspects. Phosphor layer 120 has thickness t1 within a range from 20 μm to 150 μm. Reflection layer 130 has thickness t2 that is 1.0% or more of thickness t1 of phosphor layer 120.

This configuration can increase the mechanical strength of reflection layer 130 and reduce the peeling or other problems of the layer.

For example, a phosphor device according to a fifth aspect of the present invention is an embodiment of the phosphor device according to any one of the first to fourth aspects. A percentage of pores 121 is within a range from 1% to 9% of phosphor layer 120.

This configuration can achieve both a higher efficiency of the light incident on the optical system (not shown) and less decrease in the luminous efficiency.

For example, a phosphor device according to a sixth aspect of the present invention is an embodiment of the phosphor device according to any one of the first to fifth aspects. The first metal is Ag.

This configuration can achieve a high adhesiveness and a high thermal conductivity, thereby increasing the reliability and improving the heat dissipation of the phosphor device.

For example, a phosphor device according to a seventh aspect of the present invention is an embodiment of the phosphor device according to any one of the first to sixth aspects. The phosphor device further includes: reflection layer 230 between reflection layer 130 and joint layer 140. The reflection layer have reflection characteristics different from reflection characteristics of reflection layer 130.

This configuration allows reflection layer 230 to reflect light with a large incident angle and achieves a high, stable reflectance even at a large incident angle.

For example, a phosphor device according to an eighth aspect of the present invention is an embodiment of the phosphor device according to the seventh aspect. Reflection layer 230 contains metal as a main component.

This configuration allows reflection layer 230 to reflect light with a large incident angle and achieves a high, stable reflectance even at a large incident angle.

For example, a phosphor device according to a ninth aspect of the present invention is an embodiment of the phosphor device according to the seventh or eighth aspect. The phosphor device includes planarization layer 133 between phosphor layer 120 and reflection layer 230.

This configuration can reduce the surface roughness of phosphor layer 120 and improve the film quality of the multilayer structure of reflection layer 130. In addition, the multilayer structure of reflection layer 130 can reduce the stress derived from planarization layer 133, thereby increasing the adhesiveness of phosphor layer 120 and reducing the warpage.

For example, a phosphor device according to a tenth aspect of the present invention is an embodiment of the phosphor device according to the ninth aspect. Planarization layer 133 is a closest layer to phosphor layer 120 in the multilayer structure of reflection layer 130.

This configuration can achieve both a lower dependency of the reflectance on the incident angle and a lower stress.

For example, a phosphor device according to an eleventh aspect of the present invention is an embodiment of the phosphor device according to any one of the seventh to tenth aspects. Reflection layer 130 has a thickness that is 1.0% or more and less than 10% of a thickness of phosphor layer 120.

This configuration can increase the mechanical strength of reflection layer 130 and reduce the peeling or other problems of the layer. Reflection layer 130 with a not-too-large thickness can reduce the stress and the peeling or warpage of phosphor layer 120.

For example, a phosphor device according to a twelfth aspect of the present invention is an embodiment of the phosphor device according to any one of the seventh to eleventh aspects. Reflection layer 230 is interposed between reflection layer 130 and metal layer 150.

This configuration allows reflection layer 230 to reflect light with a large incident angle and can achieve a high, stable reflectance even at a large incident angle.

### OTHERS

While the phosphor device according to the present invention has been described above based on the embodiments, the present invention is not limited to the embodiments.

For example, phosphor layer 120 and reflection layer 130 are not necessarily in contact with each other. For example, a planarization film, which is different from low-refractive layers 132, may be interposed between phosphor layer 120 and reflection layer 130.

For example, the present invention may be implemented as a method of manufacturing the phosphor device described above or as a light-emitting device including the phosphor device described above. Examples of the light-emitting device include light source devices for an image projection device and a display device as well as illumination devices.

The present invention may include forms obtained by various modifications to the foregoing embodiments that can be conceived by those skilled in the art or forms achieved by freely combining the elements and functions in the foregoing embodiments without departing from the scope and spirit of the present invention.

### REFERENCE SIGNS LIST

100, 200 phosphor device
110 substrate
120 phosphor layer
121 pore
130 reflection layer (first reflection layer)
131 high-refractive layer
132 low-refractive layer
133 planarization layer
140 joint layer
150 metal layer
160 protection layer
230 reflection layer (second reflection layer)

1. A phosphor device comprising:
a substrate;
a phosphor layer including pores;
a first reflection layer between the substrate and the phosphor layer;
a joint layer between the substrate and the first reflection layer, the joint layer containing a first metal; and
a metal layer between the first reflection layer and the joint layer, the metal layer containing a second metal having a melting point higher than a melting point of the first metal, wherein
the first reflection layer has a multilayer structure in which a high-refractive layer a low-refractive layer are alternately stacked, the low-refractive layer having a refractive index smaller than a refractive index of the high-refractive layer.

2. The phosphor device according to claim 1, wherein
the phosphor layer is made of ceramic.

3. The phosphor device according to claim 1, wherein
the phosphor layer and the first reflection layer are in contact with each other.

4. The phosphor device according to claim 1, wherein
the phosphor layer has a thickness within a range from 20 μm to 150 μm, and
the first reflection layer has a thickness that is 1.0% or more of the thickness of the phosphor layer.

5. The phosphor device according to claim 1, wherein
a percentage of the pores in the phosphor layer is within a range from 1% to 9%.

6. The phosphor device according to claim 1, wherein
the first metal is Ag.

7. The phosphor device according to claim 1, comprising:
a second reflection layer between the first reflection layer and the joint layer, the second reflection layer having reflection characteristics different from reflection characteristics of the first reflection layer.

8. The phosphor device according to claim 7, wherein
the second reflection layer contains metal as a main component.

9. The phosphor device according to claim 7, further comprising:
a planarization layer between the phosphor layer and the second reflection layer.

10. The phosphor device according to claim 9, wherein
the planarization layer is a closest layer to the phosphor layer in the multilayer structure of the first reflection layer.

11. The phosphor device according to claim 7, wherein
the first reflection layer has a thickness that is 1.0% or more and less than 10% of a thickness of the phosphor layer.

12. The phosphor device according to claim 7, wherein
the second reflection layer is interposed between the first reflection layer and the metal layer.
